(19) United States
(12) Patent Application Publication
(10) Pub. No.: US 2011/0241999 A1
(43) Pub. Date: Oct. 6, 2011

(54) KEYBOARDS FOR TOUCH-OPERATED DEVICES WITH CAPACITIVE DISPLAYS

(76) Inventor: Clifford S. Thier, Avon, CT (US)

(21) Appl. No.: 12/753,018

(22) Filed: Apr. 1, 2010

(51) Int. Cl. G06F 3/02

(52) U.S. Cl. 345/168

(57) ABSTRACT

The instant application provides a keyboard for a touch-operated device. In one embodiment, a band is provided that includes two keyboards, one for portrait mode and one for landscape mode; the band can be slipped onto the touch-operated device as needed. In another embodiment a sleeve is provided that includes front and back faces, each with a respective viewing window and keyboard to support landscape mode and portrait mode operations, respectively. Another embodiment sleeve includes a single window and two detachable keyboards, one for portrait mode and one for landscape mode, that may be affixed to the sleeve as needed.

### FIELD OF THE INVENTION

The present invention relates generally to keyboards for Touch-Operated Devices. More particularly, various embodiments disclose a keyboard for capacitive touch-screen displays that may be slipped over the display to provide haptic feedback for a keyboard image presented on the display.

### BACKGROUND OF THE INVENTION

A laptop computer traditionally has (1) a display, (2) a built-in mechanical keyboard, and (3) a pointing device (such as a computer mouse, integrated trackball, or integrated trackpad). While more easily carried than a desktop computer, a laptop computer is still bulky and weighs several pounds. It also requires a surface on which to sit so that a user may operate it.

These disadvantages have been eliminated in a new generation of small computing devices that have touch-screens instead of mechanical keyboards and pointing devices. These Touch-Operated Devices include, but are not limited to, tablet computers, smart phones, music and video players, gaming devices, global positioning devices, point-of-purchase devices, and financial transaction devices. For purposes of the following, the term “Touch-Operated Device” should be understood to cover all such small computing devices.

Many Touch-Operated Devices use a touch-screen to display an image of a computer keyboard as well as to deliver information to the user. The screen, when activated by the touch of the user's fingers at the point where a key is displayed, transmits data to the computer's microprocessor(s) and other components. This “virtual keyboard” is meant to replace the traditional physical keyboard as a method to input data and commands. Replacing a traditional keyboard with a touch-screen that both inputs data and commands and displays information saves weight and bulk.

However, unlike a physical keyboard, a touch-screen keyboard does not give the user haptic feedback (i.e., feedback via the sense of touch) indicating that the user has struck the right key and struck it successfully. Nor does a touch-screen virtual keyboard give the user any tactile guidance as to where the user should position and hold the fingers.

The earliest versions of touch-screen keyboards pressure-responsive, or “resistive,” touch-screens. The user pressed down on the touch-screen at the point where an image of a key was displayed. Resistive touch-screens have since given way to capacitive touch-screen displays for use in Touch-Operated Devices.

For capacitive touch-screen displays, the appellation “touch-screen” is not strictly true. A concise explanation of this capacitive touch-screen display technology may be had, for example, from the online encyclopedia Wikipedia. Briefly, capacitive sensing is a technology for detecting proximity, position, etc., based on capacitive coupling effects. Capacitive sensing as a human interface device (HID) technology—for example, to replace the computer mouse—is becoming increasingly popular. Capacitive sensors can be recognized in many popular consumer products such as laptop trackpads, MP3 players, computer monitors and cell phones, but it is certainly not limited to these applications. More and more engineers choose capacitive sensors for their flexibility, unique human-device interface, and cost advantages over mechanical switches. Capacitive touch sensors have become a predominant feature in a large number of mobile devices such as MP3 players, telephones, global positioning devices, and tablet computers.

Capacitive sensors detect anything that is conductive or has dielectric properties. A capacitive touch-screen panel includes an insulator such as glass, coated with a transparent conductor. As the human body is also a conductor, touching the surface of the screen results in a distortion of the body's electrostatic field, measurable as a change in capacitance. Different technologies may be used to determine the location of the touch. The location can be passed to a microprocessor or other computer circuits running a software application that will calculate how the user's touch relates to the computer software.

Projected Capacitive Touch (PCT) technology is a capacitive technology that permits more accurate and flexible operations. The greater resolution of PCT allows operation without direct contact, such that the conducting layers can be coated with further protective insulating layers, and operate even under screen protectors or behind weather- and vandal-proof glass.

However, conductive smudges and the like can seriously interfere with the resolution, making multiple touches necessary to get the desired functionality. Such conductive smudges come mostly from sticky or sweaty fingertips, especially in high-humidity environments. Collected dust, which adheres to the screen due to the moisture from fingertips, is a serious drawback for the long-life operation of PCT.

PCT is used in a wide range of applications including point-of-sale systems, smartphones, and public information kiosks, GPS devices, and tablet computers. Just a small sample of consumer devices using projected capacitive touch-screens include LG's LG KE850, Apple Inc.'s iPhone and iPod Touch, HTC's HD2, G1, and HTC Hero, Motorola's Droid, Palm Inc.'s Palm Pre and Palm Pixi and more recently the LG KM900 Arena, Microsoft's Zune HD, Sony Walkman X series, Sony Ericsson's Aino and now Vidalco's Edge, D1 and Jewel, the Nokia X6 phone and Google's Nexus One, the Apple iPad, and the HP Slate.

When typing on a capacitive touch-screen, the typist must keep his or her fingers well above the screen until one finger touches it. Inadvertent touches to the screen can type a letter, number, symbol, or command not intended by the user. In addition, absence of haptic feedback and finger placement cues slows down data entry and increases entry errors.

These two shortcomings (lack of tactile feedback, and lack of finger placement guidance) have been addressed by offering the user a separate traditional keyboard that connects to the device either with wires or with a wireless technology such as Bluetooth. However, a separate electro-mechanical keyboard accessory has its own disadvantages—and they are the same disadvantages that led to the invention of the touch-screen displays in the first place: (1) An electro-mechanical keyboard adds weight and bulk, (2) an accessory drains power from the computer's battery, or requires its own power source, and (3) an electro-mechanical keyboard needs to rest on something during operation, because a typist cannot simultaneously use a capacitive touch-screen display and a stand-alone electro-mechanical keyboard while holding the Touch-Operated Device in one hand and the stand-alone electro-mechanical keyboard in the other, whereas the user can simultaneously hold and use a Touch-Operated Device with a capacitive touch-screen display.

Accordingly, there is an immediate need for improved input devices and methods for Touch-Operated Devices built around capacitive touch-screen displays.

### SUMMARY OF THE INVENTION

Various embodiments of the invention provide a keyboard for a Touch-Operated Device—such as a dedicated computing device, a smart phone, a music player, a personal digital assistant, a video game or a tablet computer—to supply haptic feedback to the user of the device and thereby enable the user to more accurately enter data and commands into the device.

The Touch-Operated Device employs a capacitive touch-screen to display an interactive keyboard. One of the several embodiments of the invention is a continuous band incorporating a flexible keyboard bounded on each side by segments of a stretchable material. In certain embodiments, the band includes at least two keyboards because some Touch-Operated Devices can operate in two different orientations: landscape and portrait. Usually the larger of the keyboards in the band would be used when the Touch-Operated Device is operated in landscape mode, while the other, usually smaller, keyboard would be used when the Touch-Operated Device is operated in portrait mode. The band and related keyboards are preferably made from a flexible material, such as rubber, silicone, or the like. The one or more keyboards may be formed integrally with the band, so that an entire embodiment device is integrally formed.

In various embodiments, the user may slip the band around the Touch-Operated Device and then position the appropriate keyboard of the band over the image of the touch-screen keyboard displayed on the device. The band's keyboard is held in place by the tension of the stretchable segments of the band. When the user changes the Touch-Operated Device's display to the other orientation (landscape or portrait), the user may stretch the band, slip it off the Touch-Operated Device, and then slip it back on with its alternate keyboard repositioned over a resized keyboard displayed on the touch-screen.

The user may operate an embodiment by placing his or her fingers on top of the keys. Correct finger placement is aided by tactile feedback, which enables the user, without looking, to recognize the position of each key in relation to all the other keys, just as when using a standard keyboard. Additionally, the “J” key, just as on a traditional electro-mechanical keyboard, may have a small raised bar on its face to clue the user that this key is where his right index finger should rest. Such guidance is not possible with a touch-screen virtual keyboard.

The user may enter data into the Touch-Operated Device by depressing the embodiment flexible keys. When pressing a key, the user's finger interacts with the touch-screen display. In one embodiment, the tops of the keys have small holes so that by depressing a key, the user's finger comes into direct contact with the touch-screen display. In another embodiment, the keys have no holes in their tops, and hence the user's fingers do not come into direct contact with the touch-screen display; instead, the keys are made of a material that permits sensors in the touch-screen display to sense the proximity of the user's finger to the display. In both versions, the embodiment may be an integrally formed, monolithic unit, comprising the keyboards and band.

Another embodiment discloses a keyboard kit for a touch-operated device. The kit includes a first keyboard having a first plurality of keys conformal in position to corresponding keys of a first virtual keyboard of the touch-operated device and at least two tabs extending from respective sides of the first plurality of keys. Each tab has at least a respective coupling mechanism for removably fixing the first keyboard over the touch-screen display displaying the first virtual keyboard. The tabs may be made from a material that electrostatically adheres to a top surface of the touch-operated device to provide the respective coupling mechanism for each tab, or include clamps, suction cups or any other suitable coupling mechanism.

In other embodiments, the kit further includes a second keyboard having a second plurality of keys conformal in position to corresponding keys of a second virtual keyboard of the touch-operated device and at least two tabs extending from respective sides of the second plurality of keys, that tabs having coupling mechanisms for removably fixing the second keyboard over the touch-screen display displaying the second virtual keyboard.

In yet other embodiments the kit further includes a sleeve for holding the touch-operated device. The sleeve has an opening sized to enable viewing of the touch-screen display and coupling mechanisms that are respectively disposed on or in the sleeve to be interoperable with both the coupling mechanisms of the tabs of the first keyboard and the tabs of the second keyboard.

In yet another aspect a sleeve is disclosed for holding a touch-operated device. The sleeve includes a front face having a front opening sized to permit viewing of a first portion of an area of a touch-screen display of the touch-operated device, and a first keyboard conformal in shape and size to a landscape-mode virtual keyboard of the touch-operated device. The sleeve also has a back face having a back opening sized to permit viewing of a second portion of the area of the touch-screen display, and a second keyboard conformal in shape and size to a portrait-mode virtual keyboard of the touch-operated device.

An advantage of the various embodiments is that they increase the usability of the Touch-Operated Device without significantly increasing the bulk or weight of the device and without requiring a separate supporting surface. The embodiments address the disadvantages presented by a separate keyboard accessory for Touch-Operated Devices. The various embodiments may offer the following advantages:
Provide tactile feedback to the user, which improves typing speed and typing accuracy;
Provide guided finger positions to the user;
Incorporate two (or more) keyboards;
Are lighter than a mechanical keyboard;
Are less bulky than a mechanical keyboard;
Hold their keyboards in precise positions over the keyboards displayed on the touch-screen;
Do not drain the computer's battery;
Have no sensors or springs as points of failure;
Need no separate surfaces on which to rest or balance a keyboard; and
Maintain the accuracy of the touch-screen by reducing smudges on the touch-screen display.

These and other advantages will become more apparent from the following detailed discussion and as illustrated by the following figures.

### BRIEF DESCRIPTION OF THE DRAWINGS

FIG. 1A is a detailed side view of an embodiment keyboard in which each key has a hole in its top. The keyboard sits atop the touch-screen. The user's finger is shown resting on a key prior to applying pressure and activating the touch-screen display.

FIG. 1B is a top view of three keys of an embodiment keyboard showing holes in the middle of each key.

FIG. 1C is a detailed side view of an embodiment keyboard in which each key has a hole in its top. The keyboard sits atop the touch-screen. The user's finger is shown pressing down on a key, thereby coming into direct contact with the touch-screen display.

FIG. 2A is a detailed side view of another embodiment keyboard in which each key cap is made of a material that permits the capacitive touch-screen display to interact with the user's finger when the finger is proximate to the touch-screen display. The keyboard sits atop the touch-screen. The user's finger is shown resting on a key prior to applying pressure and becoming proximate to the touch-screen display.

FIG. 2B is a top view of three keys of an embodiment keyboard whose tops are made of a material that permits the capacitive touch-screen display to sense the proximity of a finger when the key is fully depressed.

FIG. 2C is a detailed side view of the keyboard shown in FIG. 2A. The user's finger is shown applying pressure to a key and thereby coming into proximity with the touch-screen display.

FIG. 3A is a top view of an embodiment device showing a larger keyboard and elastic material adjacent to each side of the keyboard.

FIG. 3B is a top view of an embodiment device showing a smaller keyboard and elastic material adjacent to each side of the keyboard.

FIG. 3C is a side view of an embodiment device showing the larger keyboard, the smaller keyboard, and elastic material between the keyboards.

FIG. 4A is a top view of a Touch-Operated Device in landscape orientation; the larger keyboard sits on the surface of the touch-screen of the device.

FIG. 4B is a bottom view of a Touch-Operated Device in landscape orientation; the smaller keyboard is shown stored on the back of the Touch-Operated Device.

FIG. 4C is a perspective view of the Touch-Operated Device shown in FIG. 4A.

FIG. 4D is a perspective view of the Touch-Operated Device shown in FIG. 4B.

FIG. 4E is a top view of a Touch-Operated Device in portrait orientation; the smaller keyboard sits on the surface of the touch-screen display.

FIG. 4F is a bottom view of a Touch-Operated Device in portrait orientation; the larger keyboard is shown stored on the back of the Touch-Operated Device.

FIG. 4G is a perspective view of the Touch-Operated Device shown in FIG. 4E.

FIG. 4H is a perspective view of the Touch-Operated Device shown in FIG. 4F.

FIG. 5A is a front view of a sleeve enclosing a Touch-Operated Device in landscape mode. Each side of the sleeve has a cut-out coverable with a flap. Integrated into the side of the sleeve shown here is a larger keyboard to be used when the device is in landscape mode.

FIG. 5B is a back view of the sleeve enclosing a Touch-Operated Device in portrait mode. Each side of the sleeve has a cut-out coverable with a flap. Integrated into the side of the sleeve shown here is a smaller keyboard to be used when the device is in portrait mode.

FIG. 6A is a top view of a larger keyboard that includes flexible keys in the center and flat tabs on each side of the keys.

FIG. 6B is a top view of a smaller keyboard that includes flexible keys in the center and flat tabs on each side of the keys.

FIG. 6C shows an embodiment sleeve for a Touch-Operated Device.

FIG. 7A is a top view of a Touch-Operated Device in landscape mode; the larger keyboard sits on the surface of the touch-screen display and is kept in position with suctions cups on the underside of the keyboard that hold the keyboard to the front frame of the Touch-Operated Device.

FIG. 7B is a top view of a Touch-Operated Device in portrait mode; the smaller keyboard sits on the surface of the touch-screen display and is kept in position with suctions cups on the underside of the keyboard that hold the keyboard to the front frame of the Touch-Operated Device.

FIG. 8A is a top view of a Touch-Operated Device in landscape mode; the larger keyboard sits on the surface of the touch-screen display and is kept in position with clamps on the outer edges of the keyboard.

FIG. 8B is a top view of a Touch-Operated Device in portrait mode; the smaller keyboard sits on the surface of the touch-screen display and is kept in position with clamps on the outer edges of the keyboard.

FIG. 9A is the top view of a sleeve enclosing a Touch-Operated Device in landscape mode. The sleeve has an opening for the touch-screen. The perimeter of the sleeve has strips of adhesive material attached to its outside surface.

FIG. 9B is a top view of a larger keyboard overlay that includes flexible keys in the center and tabs on each side of the keys. The underside of each tab has an adhesive material affixed to it on each side of the keys.

FIG. 9C is a top view that shows the keyboard from FIG. 9B sitting on the touch-screen of the sleeve-enclosed Touch-Operated Device from FIG. 9A. The keyboard is kept in position with adhesive material on the underside of the keyboard tabs that sticks to adhesive material attached to the outside of the sleeve.

FIG. 9D is a top view of a sleeve enclosing a Touch-Operated Device in portrait mode. The sleeve has an opening for the touch-screen. The perimeter of the sleeve has strips of adhesive material attached to its outside surface.

FIG. 9E is a top view of a smaller keyboard that includes flexible keys in the center and tabs on each side of the keys. The underside of each tab has an adhesive material affixed to it on each side of the keys.

FIG. 9F is a top view that shows the keyboard from FIG. 9E sitting on the touch-screen of the sleeve-enclosed Touch-Operated Device from FIG. 9D. The keyboard is kept in position with adhesive material on the underside of the keyboard tabs that sticks to adhesive material attached to the outside of the sleeve.

FIG. 10A is a top view of a sleeve enclosing a Touch-Operated Device in landscape mode. The sleeve has an opening for the touch-screen. The perimeter of the sleeve has strips of adhesive material attached to its inside surface.

FIG. 10B is a top view of a larger keyboard overlay that includes flexible keys in the center and tabs on each side of the keys. The top surface of each tab has an adhesive material affixed to it on each side of the keys.

FIG. 10C is a top view that shows the keyboard from FIG. 10B sitting on the touch-screen of the Touch-Operated Device from FIG. 10A. Both the keyboard and the Touch-Operated Device sit inside the sleeve with the keys accessible through an opening in the sleeve. The keyboard is kept in position with adhesive material on the top surface of the keyboard tabs that sticks to adhesive material attached to the inside surface of the sleeve.

FIG. 10D is a top view of a sleeve enclosing a Touch-Operated Device in portrait mode. The sleeve has an opening for the touch-screen. The perimeter of the sleeve has strips of adhesive material attached to its inside surface.

FIG. 10E is a top view of a smaller keyboard overlay that includes flexible keys in the center and tabs on each side of the keys. The top surface of the flat tabs has an adhesive material affixed to it on each side of the keys.

FIG. 10F is a top view that shows the keyboard from FIG. 10E sitting on the touch-screen of the Touch-Operated Device from FIG. 10D. Both the keyboard and the Touch-Operated Device sit inside the sleeve with the keys accessible through an opening in the sleeve. The keyboard is kept in position with adhesive material on the top surface of the keyboard tabs that sticks to adhesive material attached to the inside surface of the sleeve.

### DETAILED DESCRIPTION

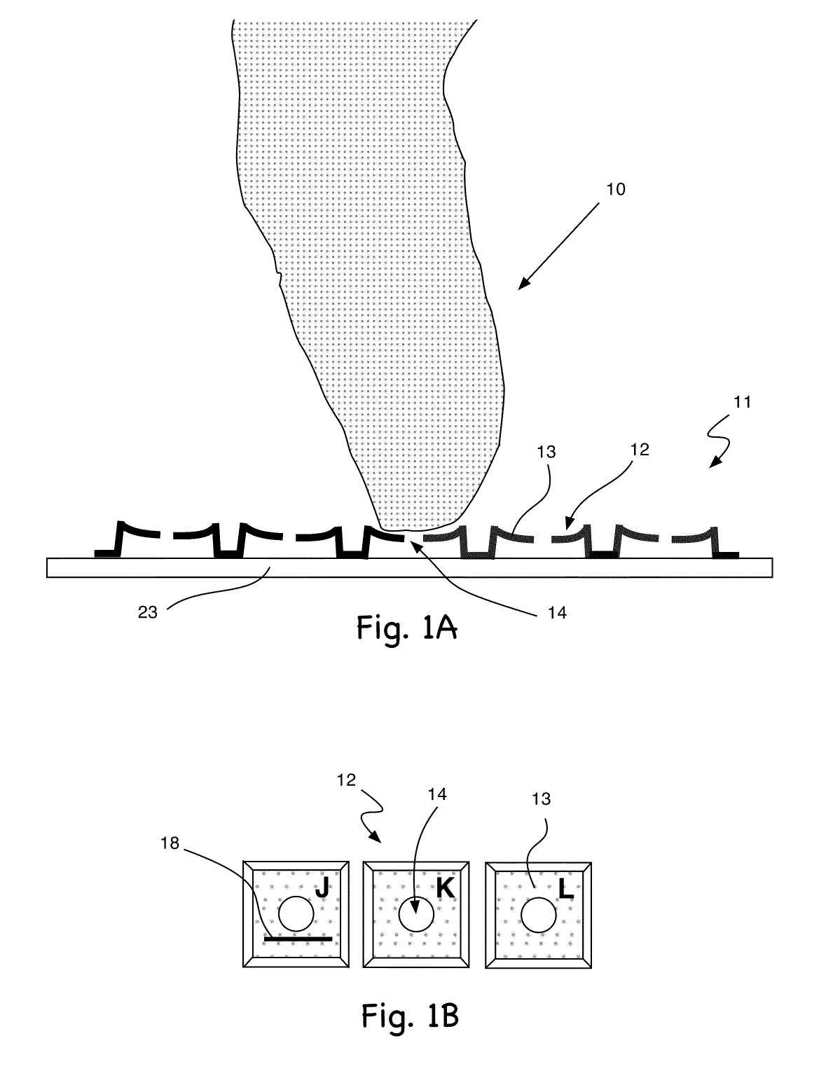

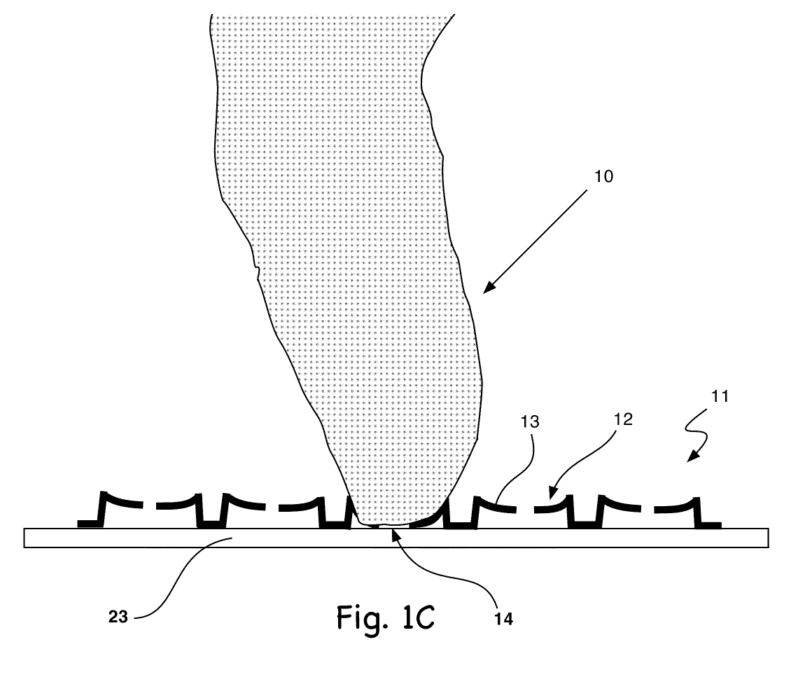

In one embodiment, as shown in detailed view in FIG. 1A, FIG. 1B, and FIG. 1C, a keyboard 11 sits on a touch-screen 23. The user's fingers, as shown with finger 10, are able to find the correct key 12 to sit on by various haptic clues such as a raised bar 18 on the “J” key 12, which mimics the raised bar on the “J” key on standard electro-mechanical computer keyboards.

In this embodiment, flexible keys 12 have holes 14 in their tops 13 that permit a user's finger 10, when depressing a key 12, to come into direct contact with the touch-screen 23 below the keyboard 11 and thereby activate the touch-screen 23 by interrupting the targeted capacitive field in the touch-screen 23. When the field is interrupted, the touch-screen 23 sends a signal to a microprocessor or other computer components.

The movement and resistance of the key 12 provides haptic feedback to the user that a particular letter, number, or command has been successfully executed or communicated to the microprocessor(s) and software running the Touch-Operated Device.

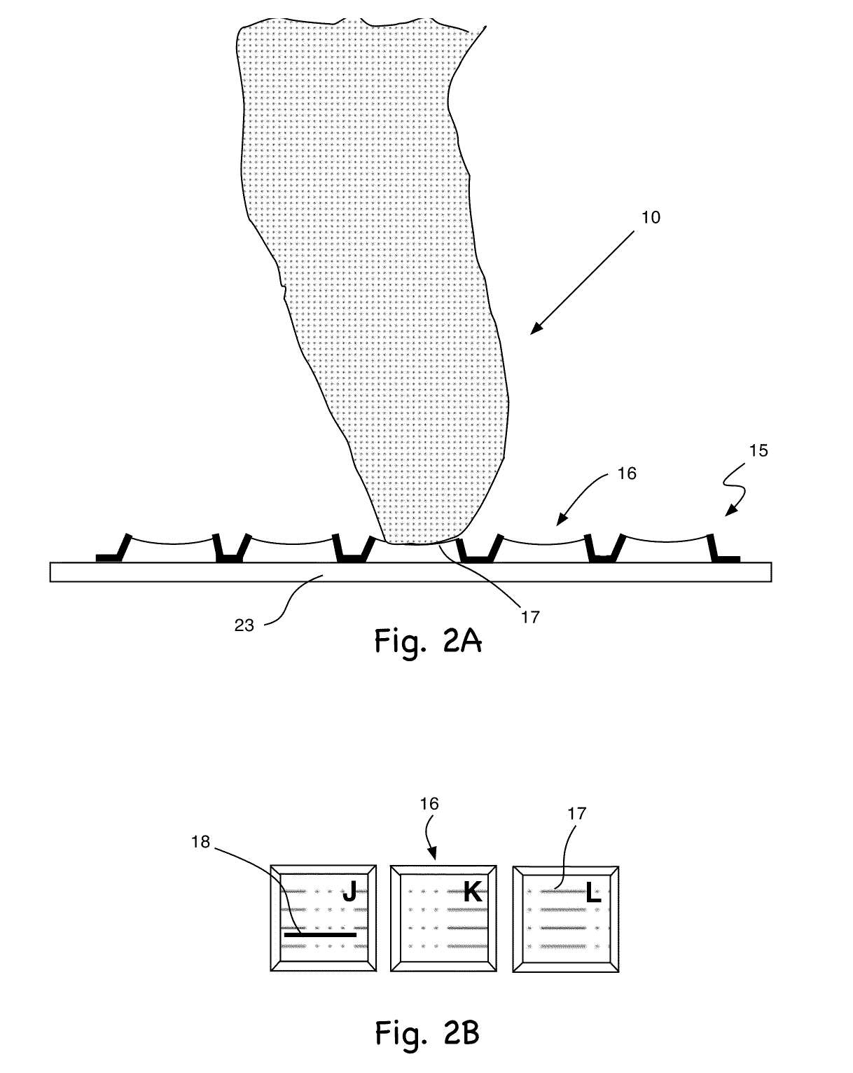

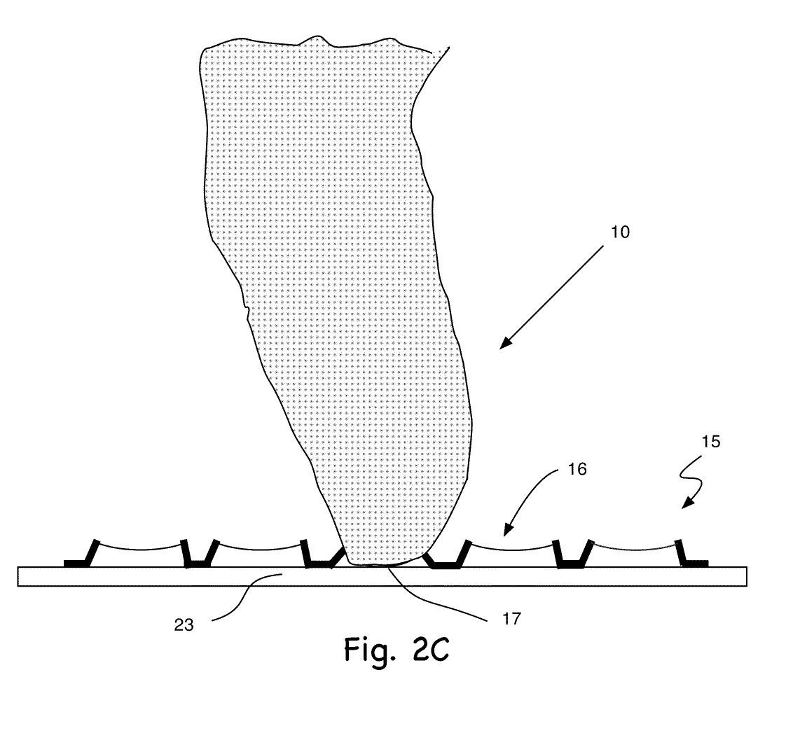

In another embodiment, as shown in detailed view in FIG. 2A, FIG. 2B, and FIG. 2C, a keyboard 15 sits on the touch-screen 23. The user's fingers, as shown with finger 10, are able to find the correct key 16 to sit on by various haptic clues such as the raised bar 18 on the “J” key 16, which mimics the raised bar on the “J” key on standard electro-mechanical computer keyboards.

In this embodiment, the flexible keys 16 do not have holes but are made of a material 17 that, when pressed, permits the touch-screen 23 to sense the presence of the user's finger 10. The presence of the finger interrupts the targeted capacitive field in the touch-screen 23. Any suitable material 17 as known in the art may be used, such as poly(ethylene terephthalate (PET)). When the field is interrupted, the touch-screen 23 sends a signal to a microprocessor or other computer components. The band 30, and keyboards, 31, 32, stretchable segments 33, and keys 13, 16, 17 will be made of a suitable material, such as Poly(ethylene terephthalate (PET)) or any other suitable polymer. Alternatively, various embodiments may be made of two or more different polymers; for example, a portion of the keyboard and keys 16 may be made of rubber, silicone or the like, while all or a portion of the top surfaces 17 of the keys 16 may be made of PET or other suitable material to permit activation of the touch-screen 23.

The movement and resistance of the keys 16 provide haptic feedback to the user that a particular letter, number, or command has been successfully communicated to the microprocessor(s) and software running on the Touch-Operated Device.

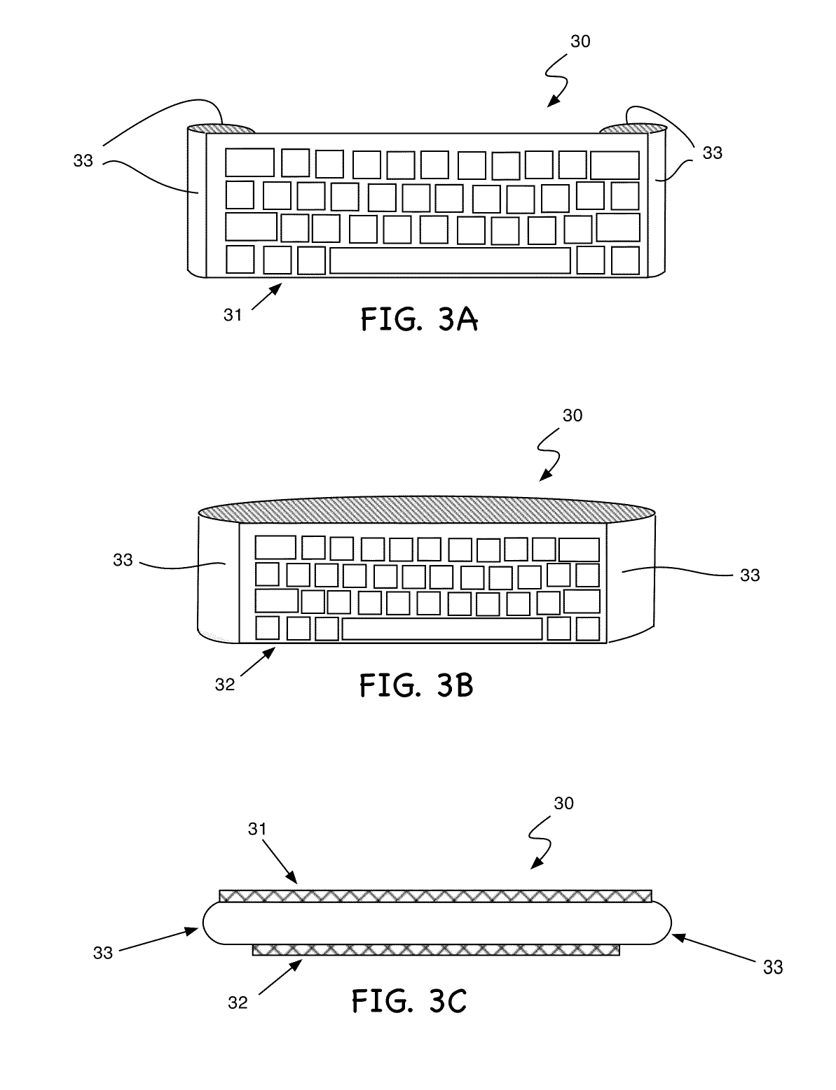

FIGS. 3A, 3B, and 3C show various views of an embodiment of a keyboard band device 30. The keyboard band device 30 includes a larger keyboard 31 and a smaller keyboard 32. Two blank elastic segments 33 couple the smaller keyboard 32 and the larger keyboard 31 together. Together, the four segments 31, 32, 33, and 33 form a single continuous loop: large keyboard 31, elastic segment 33, small keyboard 32, elastic segment 33, large keyboard 31. This loop or band 30 may then be slipped around the touch-operated device 20 to provide a suitable keyboard 31, 32 depending upon the mode that the device 20 is in.

Other embodiments may include additional keyboards in the band.

The blank segments 33 of the band 30 stretch and contract as needed so as to keep the band 30 fitting snugly around a Touch-Operated Device when the Touch-Operated Device is either in portrait (vertical) mode or in landscape (horizontal) mode. The band 30 may be made of any suitable material or materials, preferably using an elastic material for the blank segments 33. For example, in some embodiments 30 the band may be monolithic, made from rubber, silicone or the like, using keys as disclosed with reference to FIGS. 1A-1C. Or, in other embodiments, the band 30 may be made from two or more differing materials, using rubber or silicone for the segments 33, another polymer for the keyboards 31, 32 and yet another polymer, such as PET, for the tops of the keys. It will be appreciated that other variations are possible.

When the user wishes to type on the Touch-Operated Device's capacitive screen, the user instructs the Touch-Operated Device to display an image of a computer keyboard. If the user holds the Touch-Operated Device in the landscape orientation, the Touch-Operated Device will display an image of a keyboard that stretches across the wider width of this orientation. If the user holds the Touch-Operated Device in the portrait orientation, the Touch-Operated Device will display an image of a keyboard that fits across the narrower width of this orientation, as known in the field.

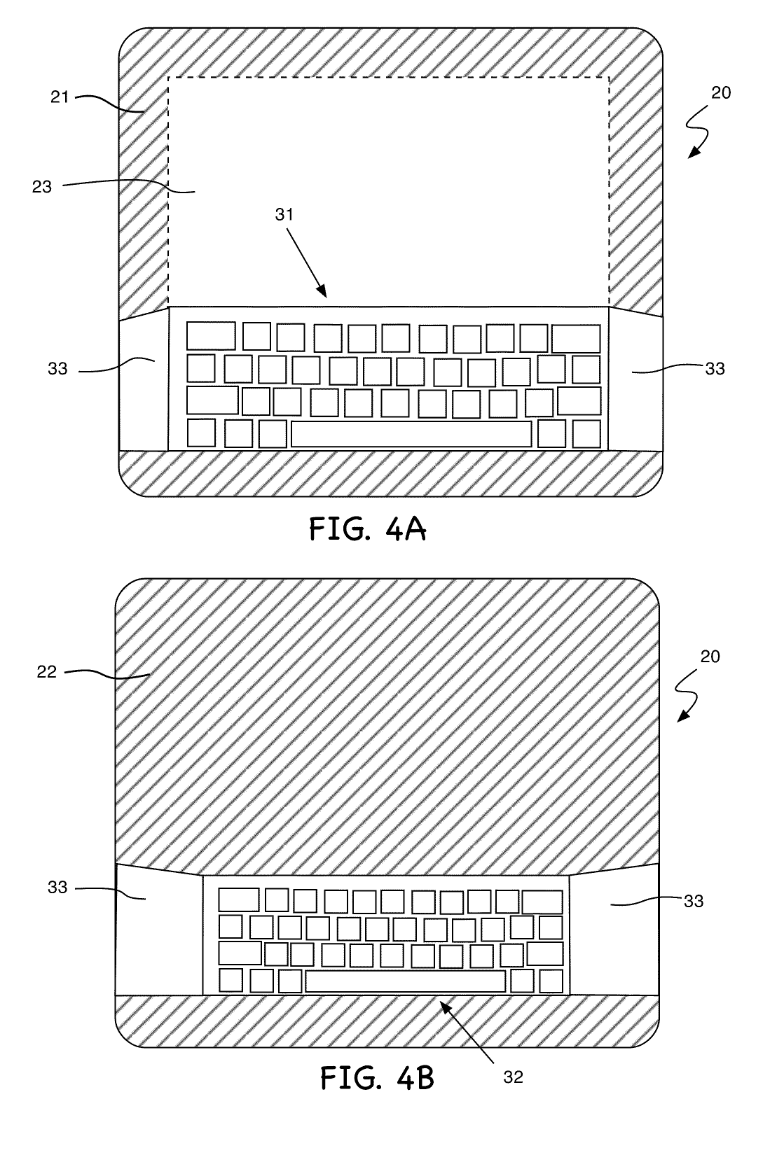

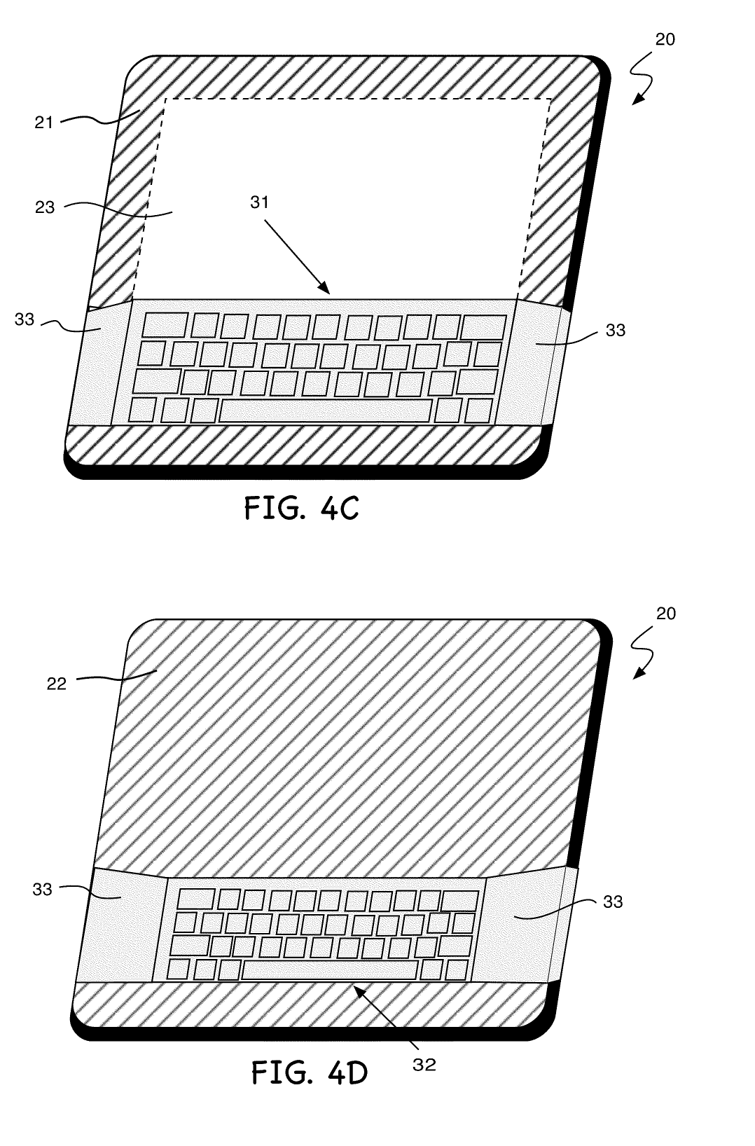

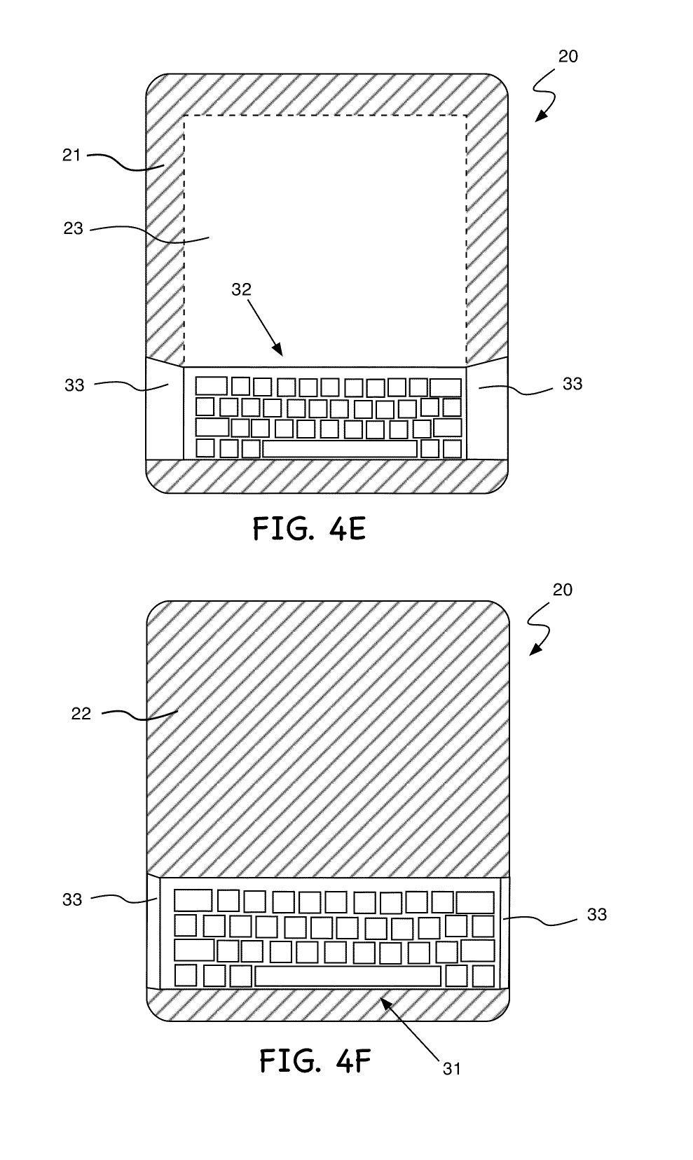

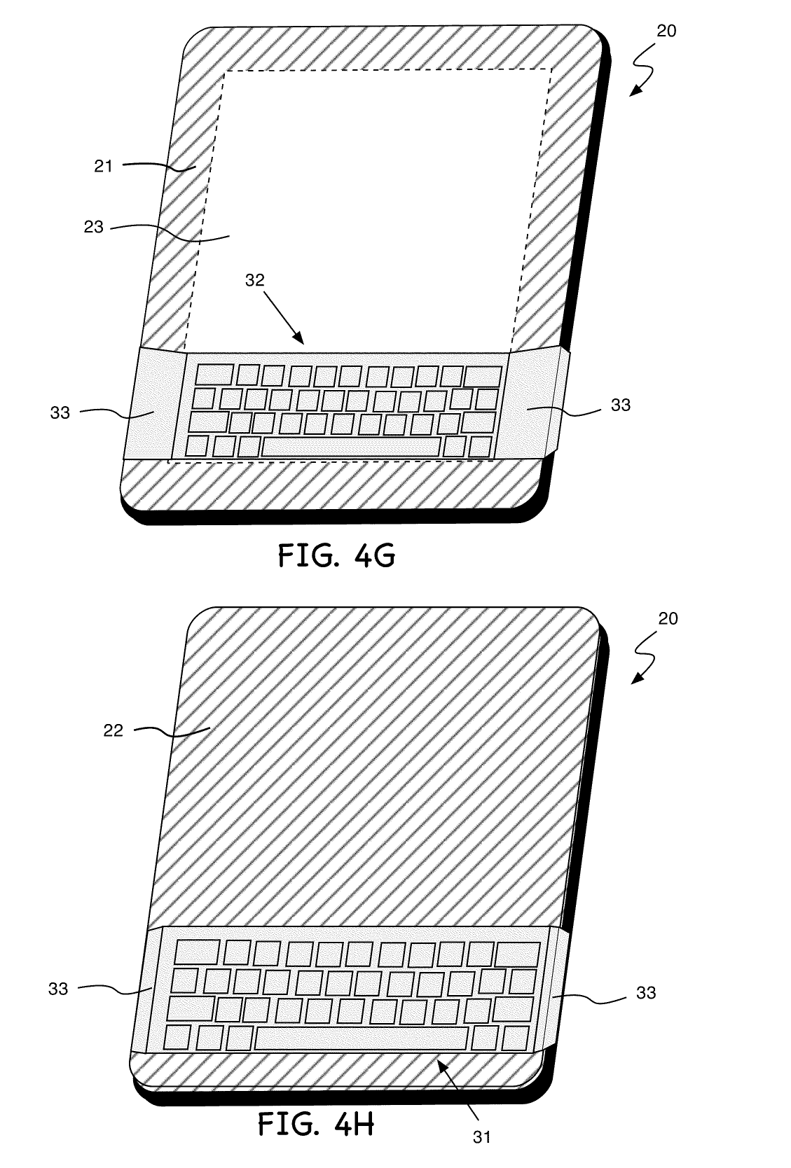

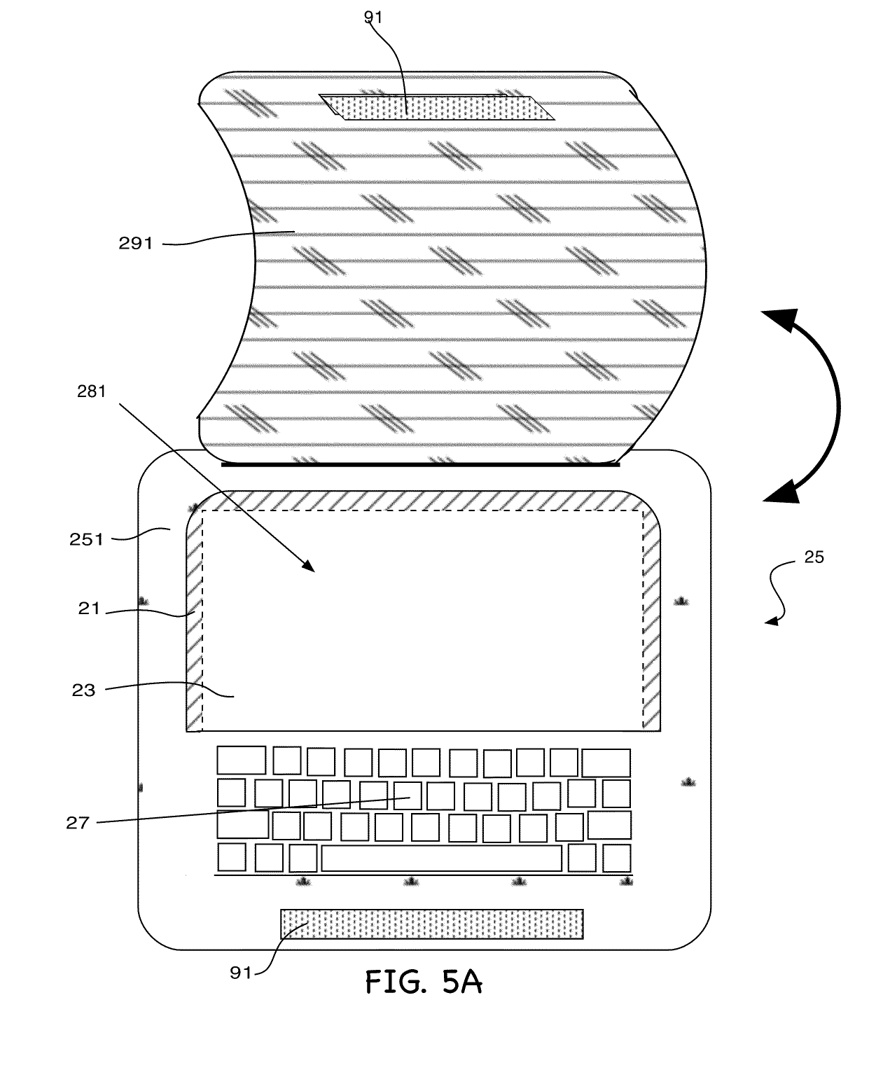

With reference to FIGS. 4A-4H, when the user of a Touch-Operated Device 20 so instructs it, the Touch-Operated Device 20 will display an image of a keyboard on its capacitive touch-screen 23, which is typically set within a bezel 21. This keyboard image will be in either the landscape mode or the portrait mode, depending on, for example, how the user holds the Touch-Operated Device. Keyboard 31 on the band 30 matches the size and layout of the landscape-mode virtual keyboard image generated and displayed on the screen 23, as shown in FIG. 4A and FIG. 4C, so that the keys of the keyboard 31 overlap and preferably perfectly align with their corresponding landscape keyboard virtual keys displayed on the touch-screen 23. Keyboard 32 on the band 30 matches the size and layout of the portrait-mode virtual keyboard image generated and displayed on the screen 23, as shown in FIG. 4E and FIG. 4G, so that the keys of the keyboard 32 overlap and preferably perfectly align with their corresponding portrait keyboard virtual keys displayed on the touch-screen 23. When the image of a particular virtual keyboard is displayed on the touch-screen 23, the user positions the matching keyboard 31, 32 on the band 30 over the image on the touch-screen 23. The elastic segments 33 stretch to fit around the Touch-Operated Device 20, and then elastically return to hold the selected keyboard 31, 32 tightly to the Touch-Operated Device 20. The elastic segments 33 keep the selected keyboard 31, 32 positioned correctly over the touch-screen image underneath it. The non-selected keyboard 31, 32 rests on the back side 22 of the Touch-Operated Device 20 as shown in FIGS. 4B, 4D, 4F, and 4H.

The user can then depress keys 12, 16 on the band's 30 keyboard 31, 32 to enter data or commands into the Touch-Operated Device 20 just as the user would if he or she were typing on a traditional computer keyboard. Hence, it will be appreciated that each keyboard 31, 32 may employ keys 12 as shown in FIGS. 1A-1C, keys 16 as shown in FIGS. 2A-2C, or combinations thereof. In some embodiments the keyboards 31, 32 and bands 33 may be monolithically made from the same piece of material, such as from rubber, silicone or the like. The relative thickness of this material may be adjusted for the bands 33 and keys 12, 16 to provide the desired elasticity, strength, etc. Such considerations are design choices well within the means of a person having ordinary skill in the art. As discussed above, in some embodiments all or a portion of the keyboards 31, 32 may be made from PET or any another polymer that will ensure activation of the display 23 when the user presses a key.

Besides embodiments in which keyboard overlays are made part of an elastic band 30, other embodiments are contemplated that provide other means of keeping the keyboard in the correct position on top of the touch-screen's virtual keyboard.

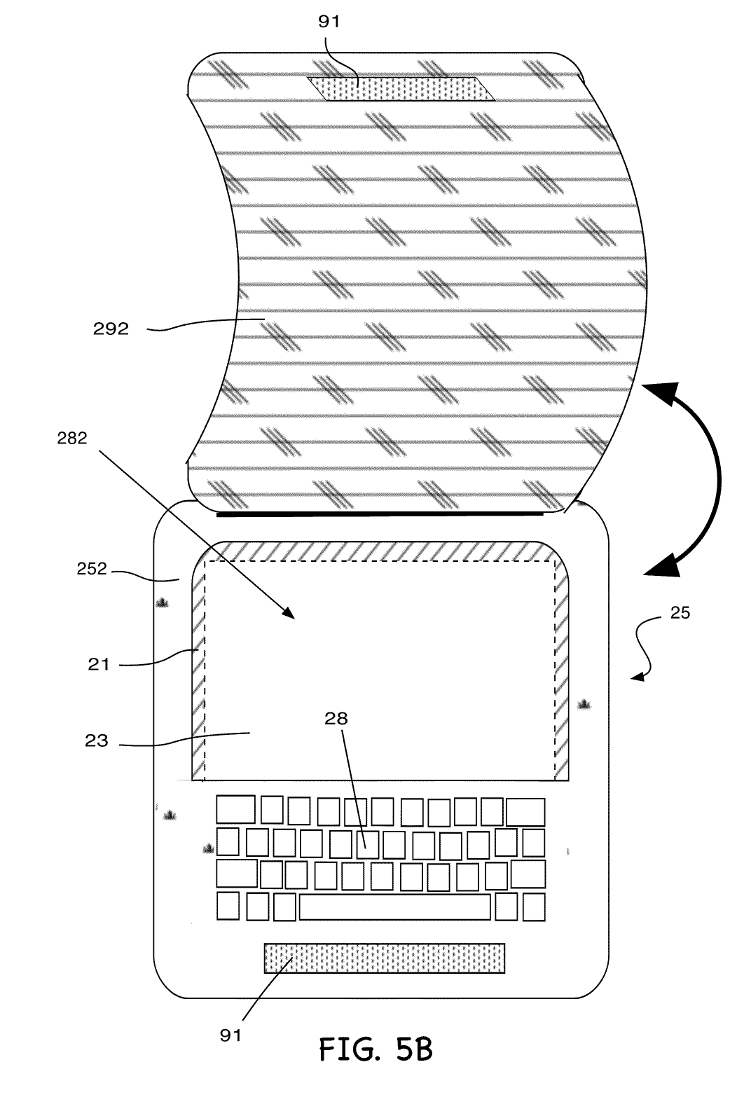

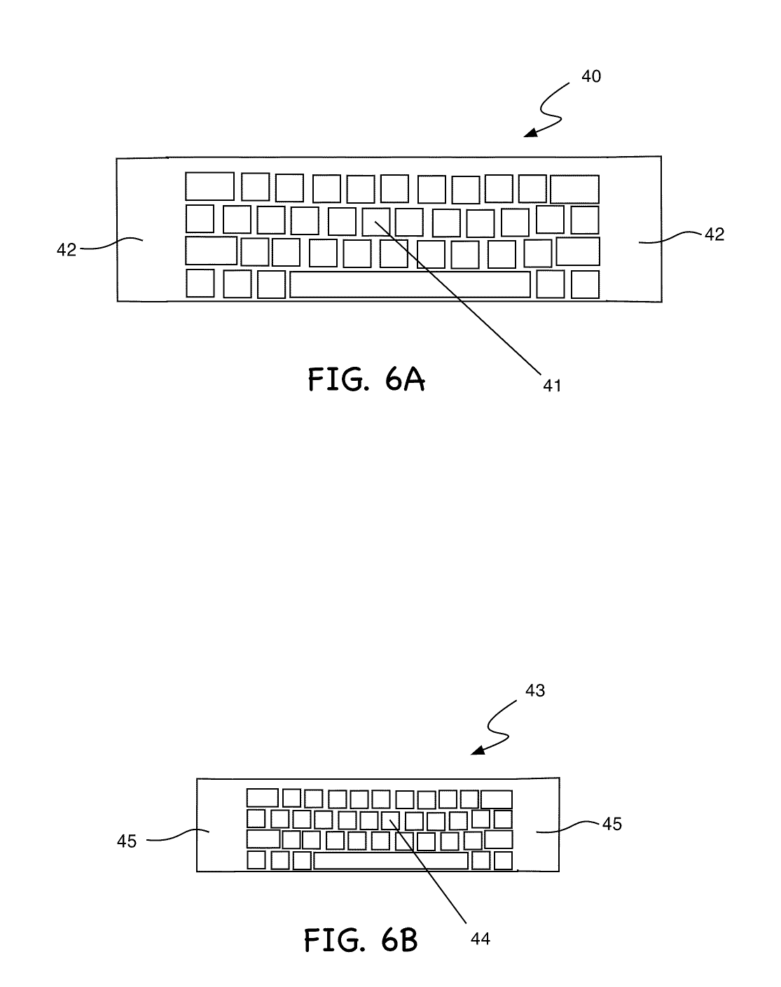

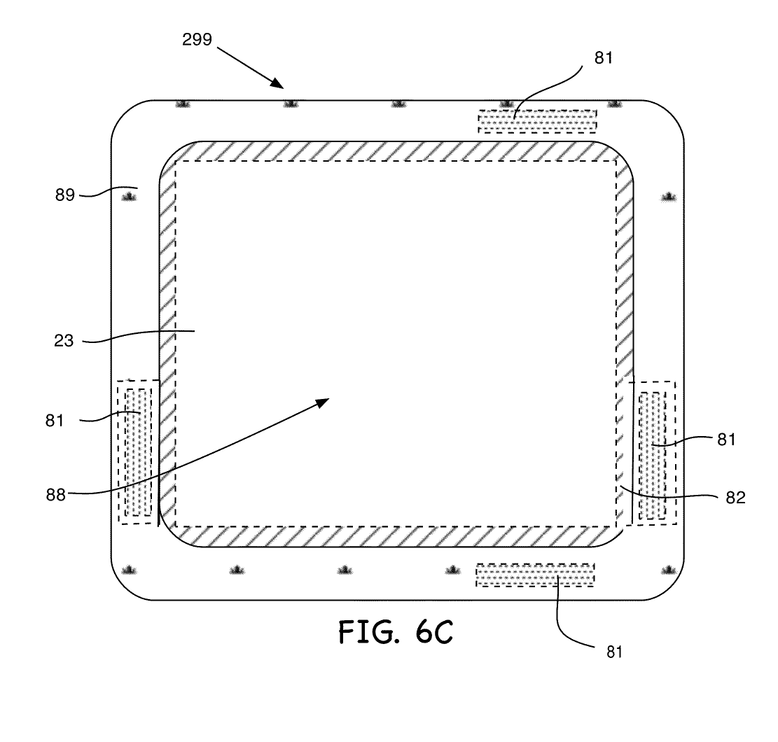

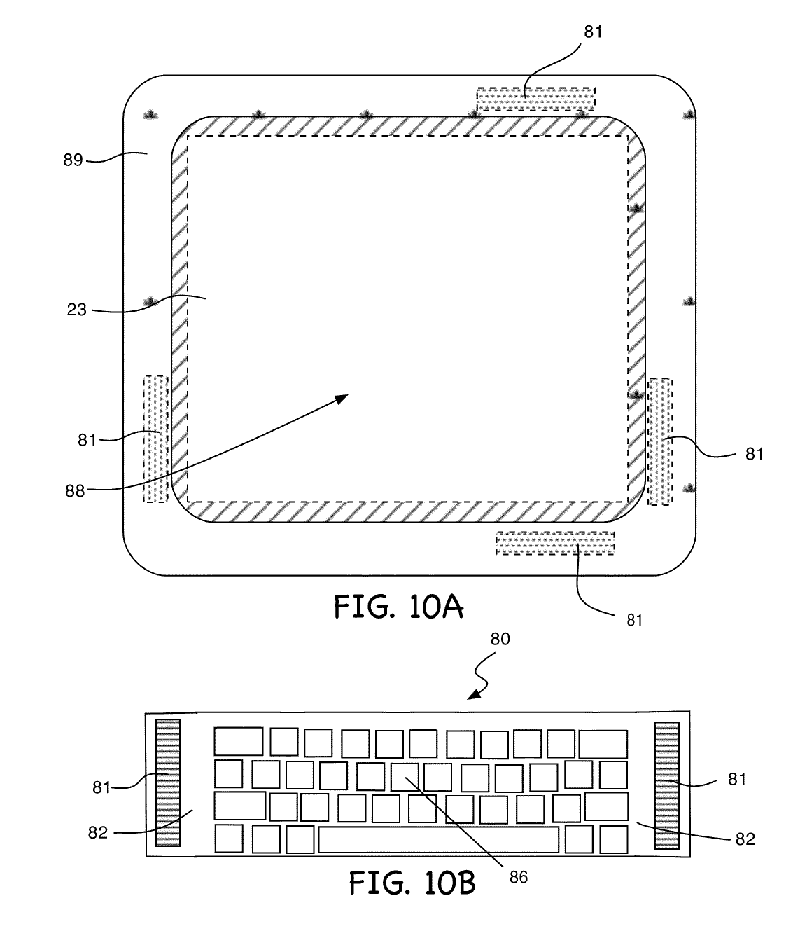

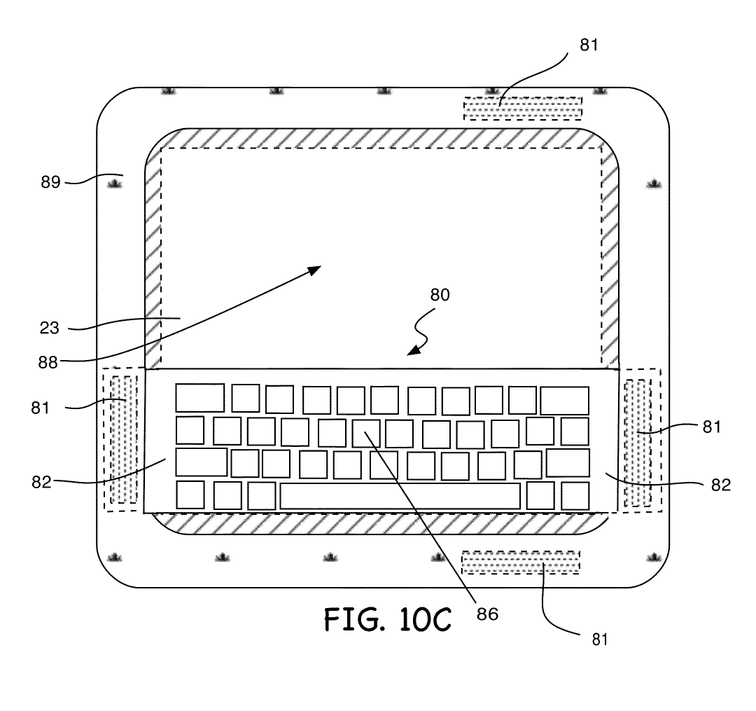

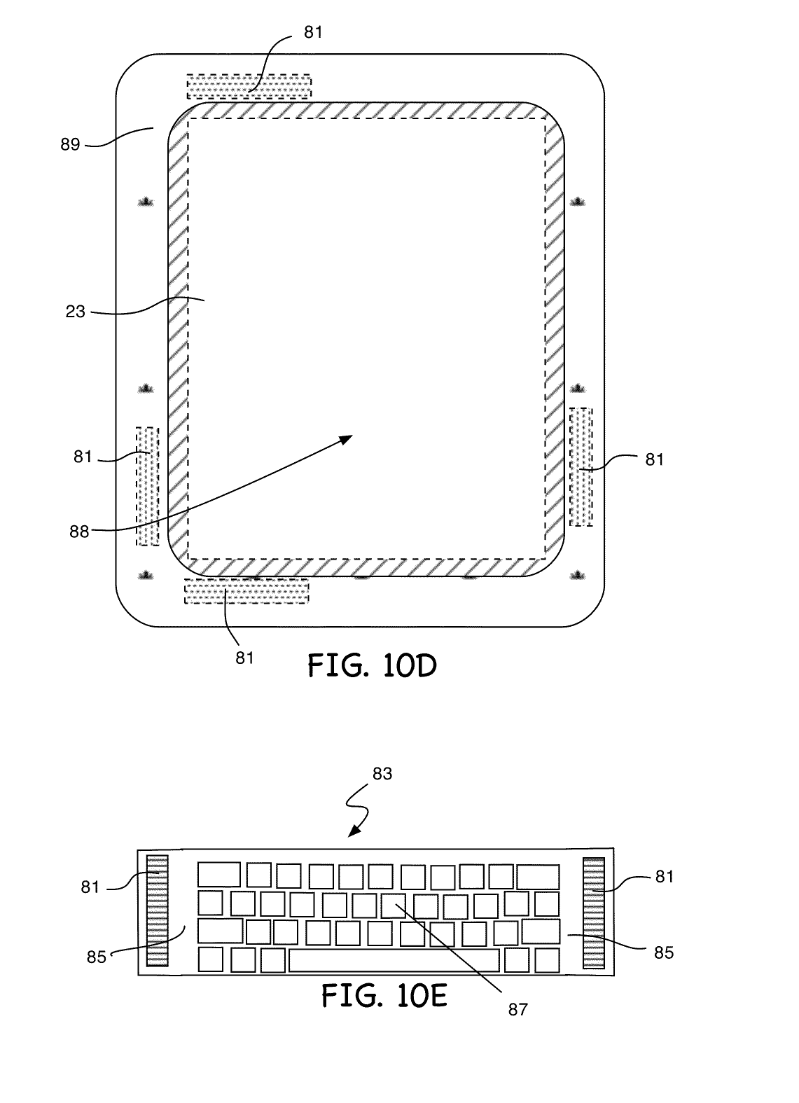

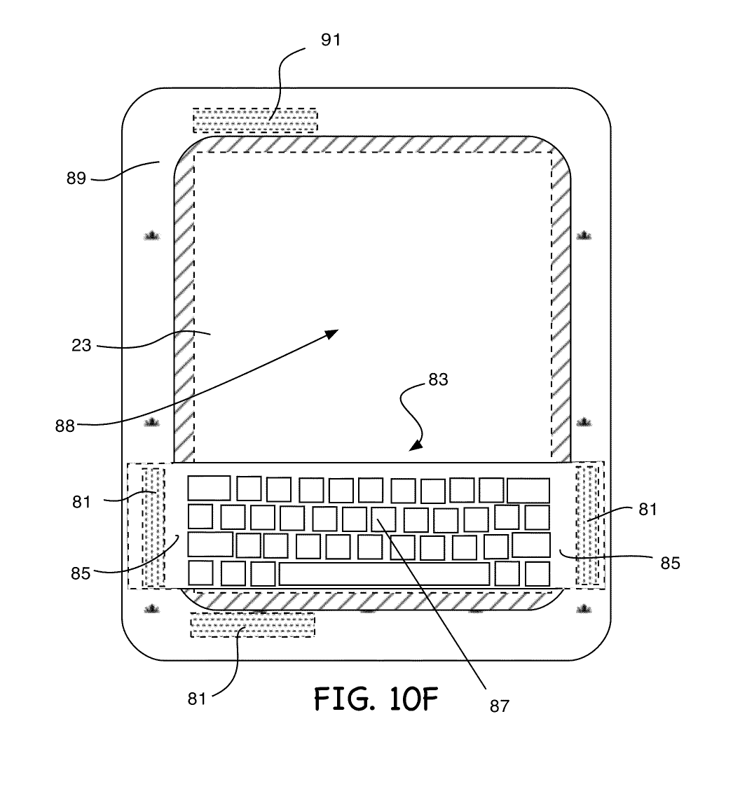

For example, as shown in FIGS. 5-6 and 9-10, a number of such embodiments make use of a sleeve or case in which a Touch-Operated Device is placed, for positioning of keyboard overlays. As shown in FIGS. 6 and 10, in some of these embodiments, two keyboard overlays with additional material (“tabs”) on each side of the keys make up the keyboards. These tabs are used in several embodiments employing different positioning and adhering strategies. Differing fixing mechanisms may be employed to mechanically couple the keyboard overlays the Touch-Operated Device, and hence hold the embodiment keys in the correct position over the virtual keys displayed on the touch-screen.

In one embodiment, as shown in FIGS. 5A and 5B, a holding device in the nature of a sleeve 25 is provided, which may be formed from front and back sides of a suitable material or combinations of materials, such as rubber, silicone, PET or another polymer or a rubber derivative or fabric such as leather or cotton. Each side of the sleeve 251 (front), 252 (back) includes an opening 281, 282 respectively. Each opening is sized to permit a user to view the viewable area of the touch-screen 23 outside of the virtual keyboard, and a respective keyboard 27 (integrated into the front 251), 28 (integrated into the back 252) that corresponds in size and layout to the corresponding virtual keyboard. When the user wishes to use the Touch-Based Device 20 in landscape mode, he or she may place the device 20 in the sleeve 25, with the touch-screen 23 facing out of the larger opening 281 on the front side 251 of the sleeve 25. When the user wishes to use the Touch-Based Device 20 in portrait mode, he or she may place the device 20 in the sleeve 25 with the touch-screen 23 facing out of the smaller opening 282 on the back side 252 of the sleeve 25. When an opening 281, 282 is not being used, it may be covered by a respective flap 291, 292. Velcro® 91 or any other suitable engaging mechanism may be used to couple the flap 291 to the sleeve's front-side 251, and flap 292 to the sleeve's back-side 252. The keyboards 27, 28 may be integrally formed with the material of the sleeve 25, or may be made from a separate material that is bonded, sewn, glued or otherwise coupled by any suitable means to the respective front 251 and back 252 sides of the sleeve 25. The keys of the keyboards 27, 28 may be of the type as described above with reference to FIGS. 1 and 2.

In another embodiment (FIGS. 6C, 9-10) a sleeve 89 is provided. The sleeve 89 is made from any suitable material or combinations of materials, such as such as rubber, silicone, PET or another polymer or a rubber derivative or fabric such as leather or cotton. The sleeve 89 has an opening or window 88 large enough to permit viewing the entire touch-screen 23 when the Touch-Operated Device 20 is inside the sleeve 89 with the touch-screen 23 facing out of the window 88. The Touch-Operated Device 20 may be inserted into the sleeve 89 by way of an opening or slit 299 along one of the edges of the sleeve 89.

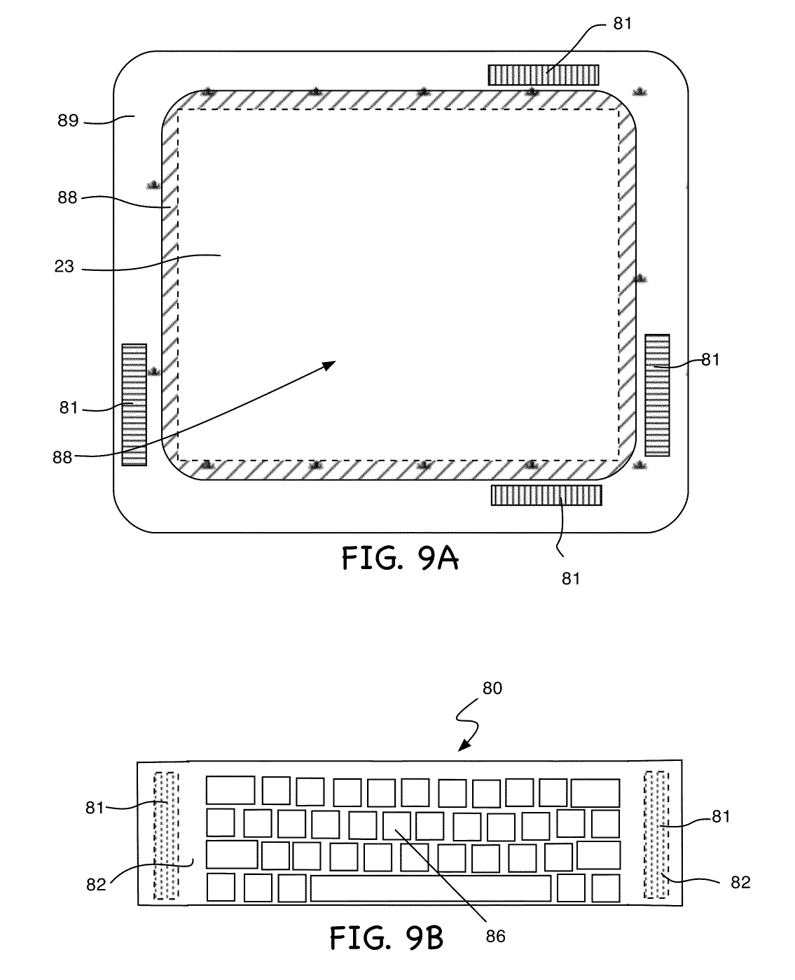

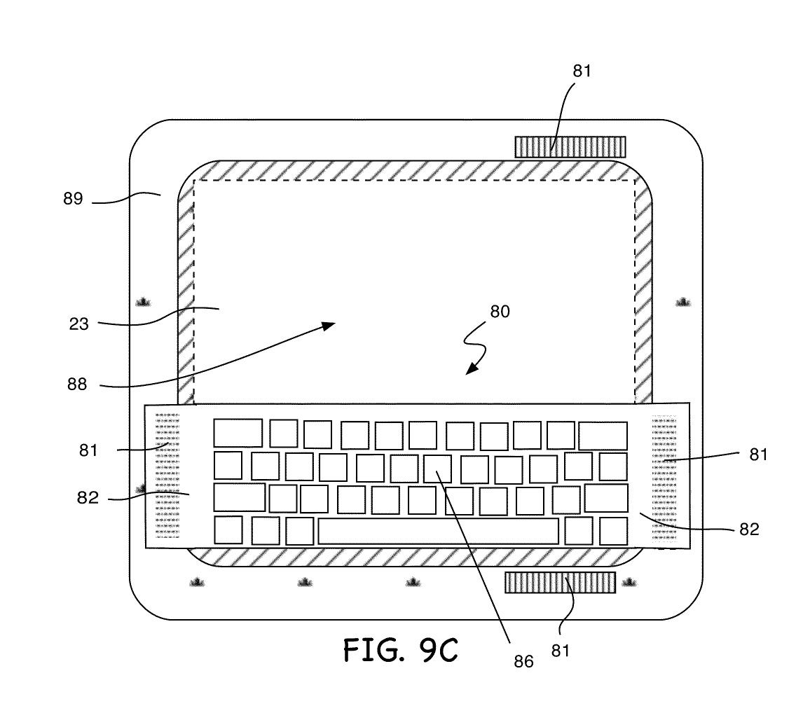

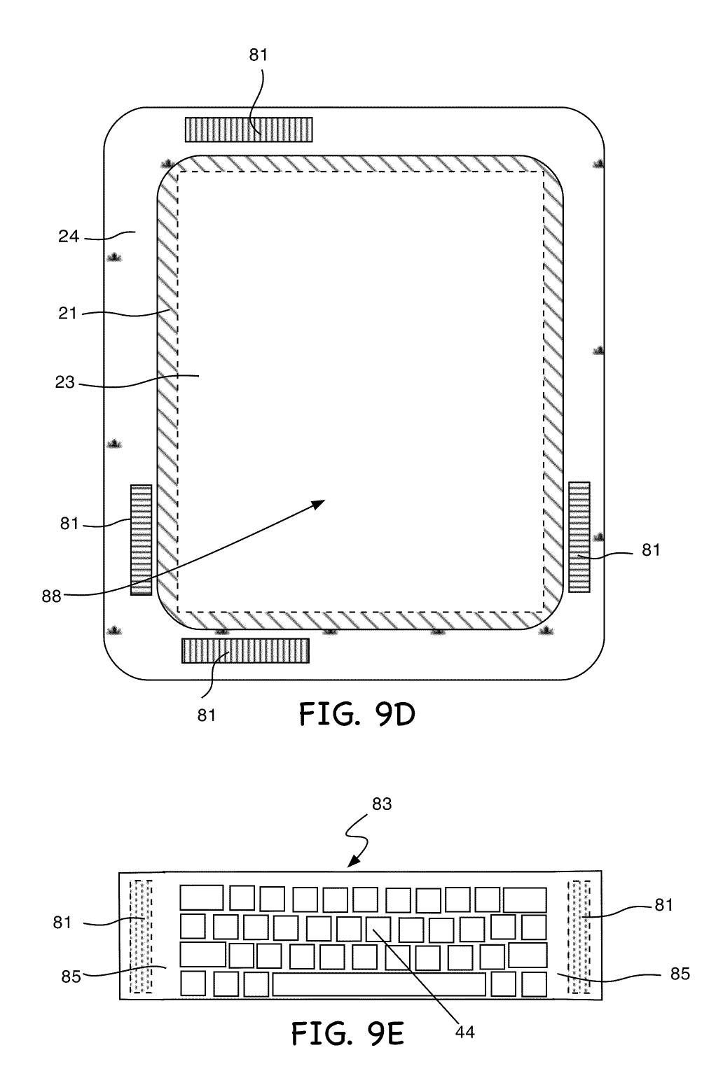

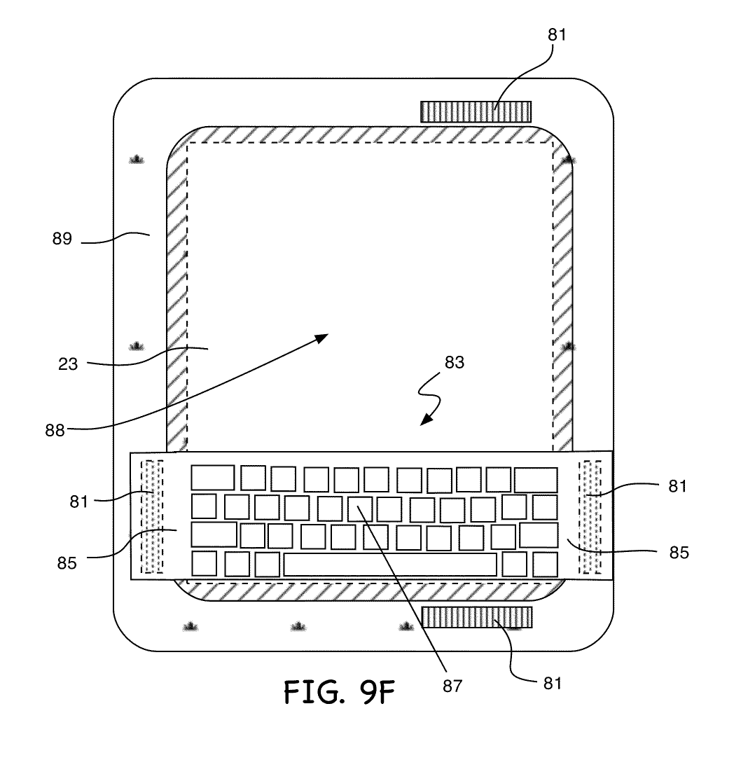

In embodiments illustrated in FIG. 9, an adhesive material 81, such as Velcro® or any other suitable attaching mechanism, such as a snap or the like, is disposed at four locations around the opening 88 on the outside of the sleeve 89. In embodiments illustrated in FIG. 10, an adhesive material 81, such as Velcro® or any other suitable attaching mechanism, such as a snap or the like, is disposed at four locations around the opening 88 on the inside of the sleeve 89.

One embodiment provides a kit that comprises two (or more) separate keyboards, as shown in FIGS. 6A and 6B. The keyboards 40, 43 may have keys 41, 44 with holes in their tops (as was shown with reference to the embodiment in FIG. 1), or may have keys 41, 44 made from a suitable material that, when pressed, permits the touch-screen 23 to sense the presence of the user's finger 10, thereby interrupting the targeted capacitive field in the touch-screen 23 (as was shown with reference to the embodiment in FIG. 2). The keyboards 40, 43 may further include tabs 42, 45 that extend outward horizontally from each end of the keyboard 40, 43. The tabs 42, 45 are used to couple the respective keyboard 40, 43 to a Touch-Operated Device 20 by way of any suitable coupling mechanism, either directly as by mechanical interaction, or indirectly as by affixation to an embodiment sleeve, discussed below. By way of an non-limiting example, the tabs 42 could be made from a material that electrostatically adheres to the top surface, such as the screen 23, bezel 21 or both, of the touch-operated device 20. In yet another embodiment kit, the keyboards 40, 43 do not have tabs but instead are made from, or include, a material that causes the keyboards to electrostatically or otherwise adhere to the top surface of the touch-operated device 20, which provides the desired coupling mechanism that enables the keyboards 40, 43 to be removably fixed to the touch-operated device 20. For purposes of the following, it will be understood that a coupling mechanism provides removable fixing of the keyboard that is sufficient to prevent moving or slippage of the keyboard during usage. Any suitable material may be used, such as is used for screen protectors and the like.

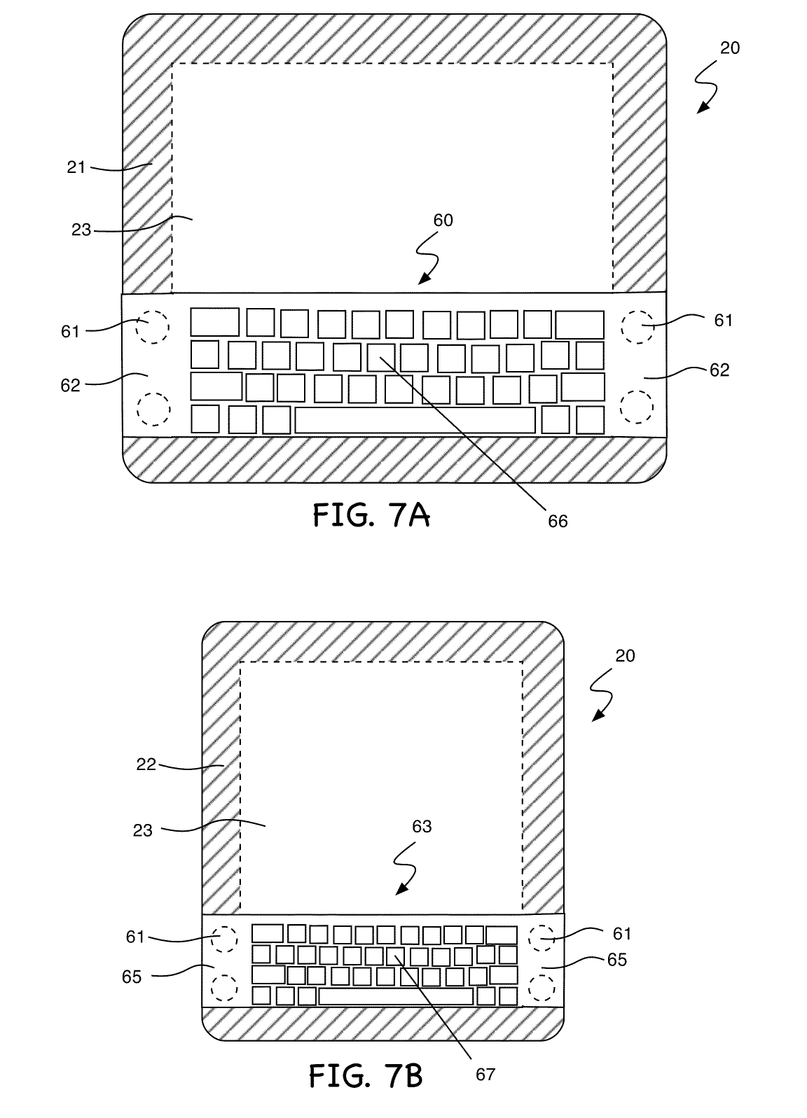

One embodiment kit that includes keyboards 60, 63 is illustrated in FIGS. 7A and 7B. Suction cups 61 are attached to the underside of tabs 62, 65. The suction cups 61 are a coupling mechanism that hold the keys 66, 67 in the correct position over the virtual keys displayed on the touch-screen 23 of the Touch-Operated Device 20. As shown in FIG. 7A, the larger keyboard 60 is designed to fit precisely over the virtual keys when the device 20 is in landscape mode. Similarly, as shown in FIG. 7B, the smaller keyboard 63 is designed to fit precisely over the virtual keys when the device 20 is in portrait mode. The suction cups 61 may adhere to, for example, the bezel 21, the touch-screen 23 or both of the Touch-Operated Device 20.

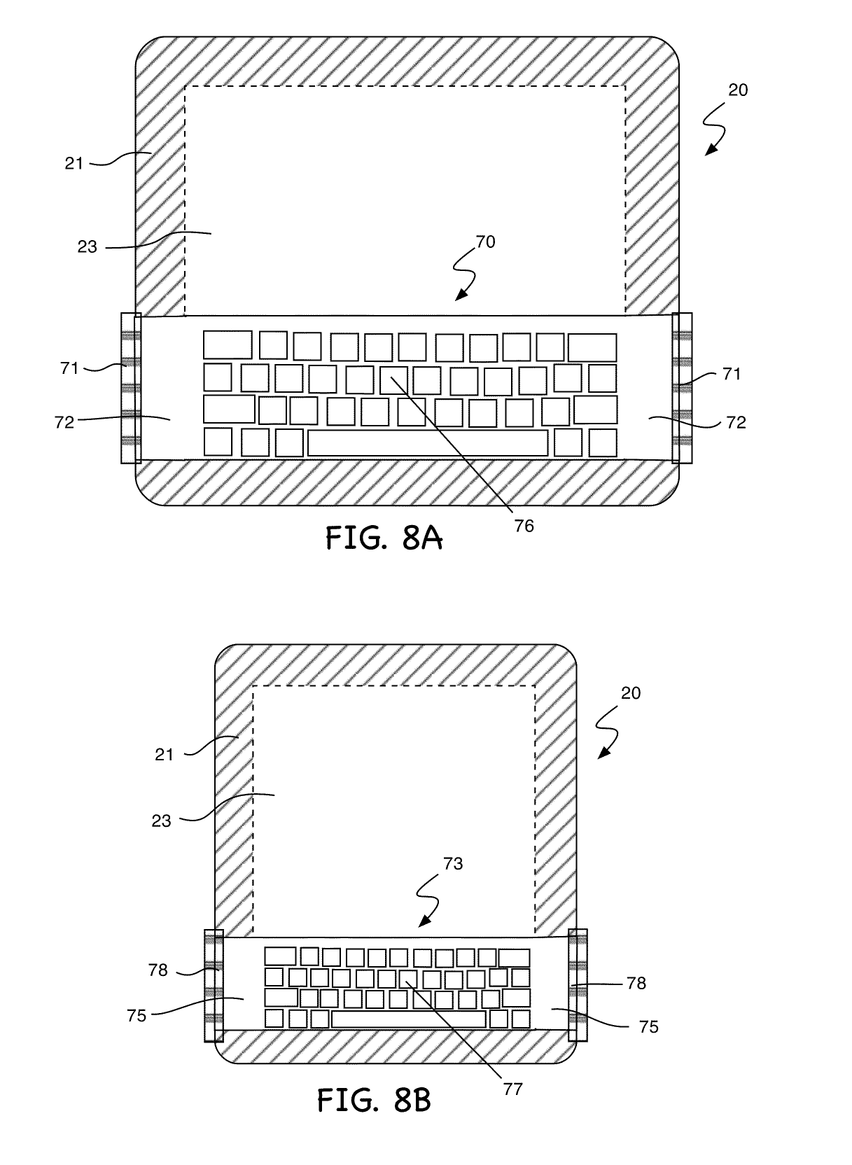

Another tab-using embodiment kit, as shown in FIGS. 8A and 8B, includes two keyboards 70, 73, and may employ suitably shaped clamps 71, 78 at the ends of the tabs 72, 75 rather than suction cups. The clamps 71, 78 serve the identical function that the suction cups described in the previous paragraph do: to hold fast the keys 76, 77 over the virtual keys displayed under them on the touch-screen 23. Any suitable material or mechanism may be employed for the clamps 71, 78 which may be formed to be conformal with the body or bezel 21 of the Touch-Operated Device 20 so as to grip and frictionally couple with the external surface of the Touch-Operated Device 20.

Another embodiment kit includes the sleeve 89, discussed above, having an opening 88 that corresponds to the entire viewing area of the touch-screen 23, and two keyboards 80, 83, as indicated in FIGS. 9A-9F. The sleeve may be made from any suitable material, as discussed above with reference to FIGS. 5A and 5B. An adhesive material 81, such as Velcro® or any other suitable attaching mechanism, such as a snap or the like, is disposed on the tops or undersides of the tabs 82, 85 of the keyboards 80, 83. As shown in FIGS. 9-10, the adhesive material 81 on the tabs 82, 85 matches up with corresponding adhesive material or attaching mechanisms 81 attached to the outside (FIG. 9) or inside (FIG. 10) surface of the sleeve 89. The materials 81 couple the keyboard 80, 83 to the sleeve 89 to keep the keys 86, 87 securely positioned over their respective virtual keys on the touch-screen display 23.

All publications cited in the specification, both patent publications and non-patent publications, are indicative of the level of skill of those skilled in the art to which this invention pertains. All these publications are herein fully incorporated by reference to the same extent as if each individual publication were specifically and individually indicated as being incorporated by reference.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the following claims.

What is claimed is:

1. A keyboard band for a touch-operated device, the keyboard band comprising:
a first keyboard conformal in shape and size to a landscape-mode virtual keyboard of the touch-operated device;
a second keyboard conformal in shape and size to a portrait-mode virtual keyboard of the touch-operated device; and
elastic material connecting the first and second keyboards together to form a band that can be slipped around the touch-operated device.

2. The keyboard band of claim 1 wherein the first keyboard and the second keyboard comprise a plurality of keys, each of the keys comprising a hole that enables a user's finger to directly contact a touch-screen of the touch-operated device.

3. The keyboard band of claim 2 wherein the keyboard band is monolithic.

4. The keyboard band of claim 1 wherein the first keyboard and the second keyboard comprise a plurality of keys, and tops of each of the keys comprise a material that enables a touch-screen of the touch-operated device to sense a user's finger when the key is depressed.

5. The keyboard band of claim 4 wherein the material is poly(ethylene terephthalate).

6. A keyboard kit for a touch-operated device, the kit comprising:
a first keyboard comprising:
a first plurality of keys conformal in position to corresponding keys of a first virtual keyboard of the touch-operated device; and
at least a coupling mechanism for removably fixing the first keyboard over a touch-screen display displaying the first virtual keyboard.

7. The kit of claim 6 wherein each of the keys comprises a hole that enables a user's finger to directly contact the touch-screen display.

8. The kit of claim 6 wherein tops of each of the keys comprise a material that enables the touch-screen to sense a user's finger when the key is depressed.

9. The kit of claim 6 wherein the first keyboard comprises a material that electrostatically adheres to a top surface of the touch-operated device to provide the coupling mechanism.

10. The kit of claim 6 wherein the first keyboard comprises at least two tabs that extend from respective sides of the first plurality of keys, each tab comprising at least one of the coupling mechanisms.

11. The kit of claim 10 wherein the tabs are made from a material that electrostatically adheres to a top surface of the touch-operated device to provide the respective coupling mechanism for each tab.

12. The kit of claim 10 wherein each tab comprises at least a suction cup.

13. The kit of claim 10 wherein each tab comprises at least a clamp.

14. The kit of claim 6 further comprising:
a second keyboard comprising:
a second plurality of keys conformal in position to corresponding keys of a second virtual keyboard of the touch-operated device; and
at least a coupling mechanism for removably fixing the second keyboard over the touch-screen display displaying the second virtual keyboard.

15. The kit of claim 14 further comprising a sleeve for holding the touch-operated device, the sleeve comprising:
an opening sized to enable viewing of the touch-screen display; and
coupling mechanisms respectively disposed on the sleeve to be interoperable with both the coupling mechanisms of the first keyboard and of the second keyboard.

16. The kit of claim 14 further comprising a sleeve for holding the touch-operated device, the sleeve comprising:
an opening sized to enable viewing of the touch-screen display; and
coupling mechanisms respectively disposed in the sleeve to be interoperable with both the coupling mechanisms of the first keyboard and of the second keyboard.

17. A sleeve for holding a touch-operated device, the sleeve comprising:
a front face comprising:
a front opening sized to permit viewing of a first portion of an area of a touch-screen display of the touch-operated device; and
a first keyboard conformal in shape and size to a landscape-mode virtual keyboard of the touch-operated device; and
a back face comprising:
a back opening sized to permit viewing of a second portion of the area of the touch-screen display; and
a second keyboard conformal in shape and size to a portrait-mode virtual keyboard of the touch-operated device.
